(19) United States
(12) Patent Application Publication
(10) Pub. No.: US 2025/0257805 A1
(43) Pub. Date: Aug. 14, 2025

(54) DIAPHRAGM VALVE AND VALVE DISK

(71) Applicant: KITZ SCT CORPORATION, Tokyo (JP)

(72) Inventors: Gihyeon SUNG, Gunma (JP); Hajime HORIGUCHI, Gunma (JP)

(21) Appl. No.: 19/041,263

(22) Filed: Jan. 30, 2025

(30) Foreign Application Priority Data
Feb. 9, 2024 (JP) 2024-18524

(51) Int. Cl. F16K 1/46; F16K 41/12

(52) U.S. Cl. CPC F16K 1/46; F16K 41/12

(57) ABSTRACT

A diaphragm valve including a valve disk suspended by a diaphragm airtightly sealing a valve chamber, and is moved in conjunction with a stem so that an annular seal member is at a valve closing position at which the annular seal member abuts on a valve seat surface or at a valve opening position at which the annular seal member is apart from the valve seat surface. The valve disk includes: a seal retention member including a cylindrical portion and retaining the annular seal member at a position concentric with a retention portion; and an annular cushion member sandwiched between the seal retention member and the annular seal member and retained in an annular accommodation portion at a position concentric with the retention portion. The annular seal member is retained in the annular accommodation portion so that the annular seal member extends more radially outwardly than the annular cushion member.

### BACKGROUND OF THE INVENTION

### Field of the Invention

The present invention relates to a diaphragm valve and a valve disk. In particular, the present invention relates to a diaphragm valve and a valve disk, in which the valve disk suspended in a state in which a valve chamber is airtightly sealed is moved to a valve opening and closing position in conjunction with a stem.

### Description of the Related Art

Conventionally, it has been required that opening and closing valves used in the gas supply piping systems of semiconductor manufacturing apparatuses, solar battery manufacturing apparatuses, liquid crystal manufacturing apparatuses, and the like have small dead spaces to suppress generation of particles. Diaphragm valves have been often used as valves meeting such requirements.

Examples of the diaphragm valves include a diaphragm valve in which a sealing element such as a valve seat is disposed on a valve disk side rather than on a body side. Such a valve disk is moved in conjunction with the movement of a stem.

For enhancing the airtightness between a valve seat and a valve disk in a valve closing state, such a valve requires improvement in the followability of a sealing element disposed on the valve disk to a valve seat surface and improvement in performance for alignment of the valve disk in a state in which the valve disk is suspended.

With current demand for high heat resistance, it has become important to maintain airtightness in cases including, for example, use under a high-temperature environment using a control fluid at a high temperature of 300° C. or more.

Various technologies have been proposed to meet such various demands.

For example, Japanese Patent Laid-Open No. 62-288786 describes a diaphragm valve including an actuation mechanism enabling a diaphragm and a valve element in cooperation with the diaphragm to be moved between an open position and a closed position without allowing the diaphragm and the valve element to receive a twisting load.

When closure movement of the diaphragm valve described in Japanese Patent Laid-Open No. 62-288786 proceeds, a compressive force exerted between a valve seat region and the sealing surface 167 of an elastic seal ring 160 is increased. A force between the valve seat region and the corner 156 of a rigid ring 152 is also increased. However, the degree of the increase is low. The reason thereof is because a ring 158 with low rigidity and still more elasticity still more easily receives a compressive force to move the rigid ring 152 backward toward a main portion 78 and the elastic seal ring 160 to a certain degree. This action enables the rigid ring 152 to continuously come into contact with the valve seat region while increasing a sealing pressure between the surface 167 and the valve seat region. A compressive force exerted in the elasticity seal ring 160 allows a downward force to be continuously exerted on a sleeve 166 by a flange 168. When the valve is finally closed, the lower edge of the sleeve 166 is brought into line contact with the valve seat region and the circumference of the elastic seal ring 160.

Japanese Utility Model Laid-Open No. 4-117971 describes a bellows seal valve in which a valve disk 9 suspended by a bellows 12 is moved to a valve opening and closing position in conjunction with a valve shaft 10 (corresponding to a stem), as a valve using a suspended valve disk rather than as a diaphragm valve.

In the bellows seal valve, the valve disk 9 supported on the valve shaft 10 that can axially reciprocate includes a sheet metal 14 that can abut on an annular valve seat 8 protruded from the wall of a valve chamber 4, and a blank 15 is disposed behind the sheet metal 14. A cushion member 16 is accommodated together with a support member 17 in the blank 15.

Like Japanese Utility Model Laid-Open No. 4-117971, Japanese Utility Model Laid-Open No. 61-168375 describes a bellows valve in which a valve disk 14 suspended by a bellows 13b is moved to a valve opening and closing position in conjunction with a spindle 16 (corresponding to a stem).

In the bellows valve, packing 30 is sandwiched between the bottom surface 14a of the valve disk 14 and the bottom surface 20a of a disk 20.

### BRIEF SUMMARY OF THE INVENTION

However, the diaphragm valve described in Japanese Patent Laid-Open No. 62-288786 has had a problem that the elastic seal ring 160 which is a principal sealing element for securing the airtightness between a valve seat and a valve disk in a valve closing state is sandwiched and tightened between the rigid ring 152 and the sleeve 166, and therefore, it is difficult to sufficiently exhibit original cushioning properties, and, as a result, it is difficult to enhance airtightness.

The bellows seal valve described in Japanese Utility Model Laid-Open No. 4-117971 has had a problem that a mechanism 18 for alignment is disposed in the valve disk 9 to perform alignment, and therefore, the valve disk 9 has a complicated configuration.

In the bellows valve described in Japanese Utility Model Laid-Open No. 61-168375, the packing 30 is merely sandwiched to axially overlap with the bottom surface 14a of the valve disk 14 and the bottom surface 20a of the disk 20, a specific configuration in which the packing 30 is retained at a position concentric with the axis is not disclosed, and therefore, it is impossible to expect a function of alignment by the valve disk 14. Moreover, projections 23 and 24 protruded to the backside of the bottom surface 20a of the disk 20 are brought into press contact with the bottom surface 14a of the valve disk 14 from below to seal the surface, and therefore, it is difficult to sufficiently exhibit the cushioning properties of the packing 30.

Therefore, the bellows valve described in Japanese Utility Model Laid-Open No. 61-168375 has had a problem that it is difficult to enhance airtightness.

The present invention is developed to solve the conventional problems. An objective of the present invention is to provide a diaphragm valve and a valve disk, having simple configurations, and enabling enhancement of airtightness while having an alignment function, even under an environment at wide temperatures.

In order to achieve the objective described above, the invention according to claim 1 is a diaphragm valve including a valve disk that is suspended by a diaphragm airtightly sealing a valve chamber, includes a retention portion retaining an annular seal member in an annular accommodation portion, and is moved in conjunction with a stem so that the annular seal member is at a valve closing position at which the annular seal member abuts on a valve seat or at a valve opening position at which the annular seal member is apart from the valve seat, wherein the valve disk includes: a seal retention member including a cylindrical portion mating a cylindrical inner surface with an inner peripheral surface of the annular accommodation portion, and retaining the annular seal member at a position concentric with the retention portion; and an annular cushion member that is sandwiched between a surface, facing a bottom surface of the annular accommodation portion, of the seal retention member and the annular seal member, and the bottom surface, includes an inner peripheral surface mated with an inner peripheral surface of the annular accommodation portion, and is retained in the annular accommodation portion at a position concentric with the retention portion, and the annular seal member is retained in the annular accommodation portion in a state in which the annular seal member extends more radially outwardly than the annular cushion member, and a gap is formed between a surface of the annular seal member, facing the bottom surface of the annular accommodation portion, and the bottom surface.

The invention according to claim 2 is the diaphragm valve, wherein the annular cushion member includes a material of which a cushioning property is higher than that of the annular seal member.

The invention according to claim 3 is the diaphragm valve, wherein the sheet retention member includes a collar portion radially outwardly protruded in a collar shape on an end of the cylindrical portion, and a stage-shaped abutment surface abutting in a stage shape on an outer peripheral surface of the cylindrical portion including the collar portion is formed on the annular seal member.

The invention according to claim 4 is the diaphragm valve, wherein a recess in which the annular cushion member is placed is formed on the annular seal member so that the surface, facing the bottom surface of the annular accommodation portion, of the annular seal member, is provided with a peripheral side slightly separated from an outer peripheral surface of the annular cushion member, and the gap is formed between the bottom surface of the annular accommodation portion and a surface of the annular seal member that is more radially outwardly than the recess.

The invention according to claim 5 is the diaphragm valve, wherein the annular seal member includes a polyimide resin, and the annular cushion member includes a perfluoroalkoxy alkane resin.

The invention according to claim 6 is a valve disk that is suspended by a diaphragm airtightly sealing a valve chamber, includes a retention portion retaining an annular seal member in an annular accommodation portion, and is moved in conjunction with a stem so that the annular seal member is at a valve closing position at which the annular seal member abuts on a valve seat surface or at a valve opening position at which the annular seal member is apart from the valve seat surface, wherein the valve disk includes: a seal retention member including a cylindrical portion mating a cylindrical inner surface with an inner peripheral surface of the annular accommodation portion, and retaining the annular seal member at a position concentric with the retention portion; and an annular cushion member that is sandwiched between a surface, facing a bottom surface of the annular accommodation portion, of the seal retention member and the annular seal member, and the bottom surface, includes an inner peripheral surface mated with an inner peripheral surface of the annular accommodation portion, and is retained in the annular accommodation portion at a position concentric with the retention portion.

In accordance with the invention according to claim 1, the valve disk includes: the seal retention member including the cylindrical portion mating the cylindrical inner surface with the inner peripheral surface of the annular accommodation portion, and retaining the annular seal member at the position concentric with the retention portion; and the annular cushion member that is sandwiched between the surface, facing the bottom surface of the annular accommodation portion, of the seal retention member and the annular seal member, and the bottom surface, includes the inner peripheral surface mated with the inner peripheral surface of the annular accommodation portion, and is retained in the annular accommodation portion at the position concentric with the retention portion, and the annular seal member is retained in the annular accommodation portion in a state in which the annular seal member extends more radially outwardly than the annular cushion member, and the gap is formed between the surface of the annular seal member, facing the bottom surface of the annular accommodation portion, and the bottom surface.

As a result, due to a simple configuration in which the annular cushion member mated with the inner peripheral surface of the annular accommodation portion, and retained at the position concentric with the retention portion on the bottom surface side of the annular accommodation portion, and the gap between the annular seal member in the outer-diameter region of the annular cushion member and the bottom surface of the annular accommodation portion are disposed, in the case of compressing the annular cushion member toward the bottom surface of the annular accommodation portion, the annular seal member abutting on the valve seat is compressed together with the annular cushion member toward the bottom surface while effectively exhibiting the cushioning property of the annular cushion member with the use of the gap between the annular seal member and the annular accommodation portion, and is deformed for alignment with the use of the gap.

The annular cushion member is positioned on the bottom surface side of the annular accommodation portion, and is prevented from coming into contact with a control fluid by the seal retention member and the annular seal member. Therefore, the deterioration of the cushioning property due to the influence of temperature can be prevented, and a material with a high cushioning property can be used in the annular cushion member even if the heat resistance of the material is lower than that of the annular seal member.

Therefore, in accordance with the invention according to claim 1, performance for alignment can be improved while keeping airtightness in a simple configuration even under an environment at wide temperatures.

In accordance with the invention according to claim 2, the annular cushion member includes the material of which the cushioning property is higher than that of the annular seal member. Therefore, the followability of the annular seal member to the valve seat surface is enhanced with the use of the cushioning property of the annular cushion member, and, as a result, airtightness can be enhanced.

In accordance with the invention according to claim 3, the seal retention member includes the collar portion radially outwardly protruded in the collar shape on the end of the cylindrical portion, and the stage-shaped abutment surface abutting in the stage shape on the outer peripheral surface of the cylindrical portion including the collar portion is formed on the annular seal member. Therefore, in a case in which the annular seal member abuts on the valve seat and is compressed, the entry of a control fluid through the stage-shaped abutment portion between the seal retention member and the annular seal member is prevented even if the annular seal member is relatively moved in the axis direction with respect to the seal retention member, and therefore, the control fluid can be prevented from entering the gap between the annular seal member and the bottom surface of the annular accommodation portion.

In accordance with the invention according to claim 4, the recess in which the annular cushion member is placed is formed on the annular seal member so that the surface, facing the bottom surface of the annular accommodation portion, of the annular seal member, is provided with the peripheral side slightly separated from the outer peripheral surface of the annular cushion member, and the gap is formed between the bottom surface of the annular accommodation portion and the surface of the annular seal member that is more radially outwardly than the recess. Therefore, such a minimum gap that the annular cushion member can exert cushion performance can be disposed, and, as a result, the minimum gap that enables airtightness to be enhanced can be disposed.

In accordance with the invention according to claim 5, the annular seal member includes a polyimide, and the annular cushion member includes a perfluoroalkoxy alkane resin. Therefore, performance for alignment can be improved while keeping airtightness in a simple configuration even in use under an environment at 300° C. or more because the annular cushion member including a perfluoroalkoxy alkane resin of which the cushioning property is higher than that of the polyimide resin although the perfluoroalkoxy alkane resin has resistance to heat at less than 300° C. is used in a portion that does not come into contact with a control fluid while the annular seal member including a polyimide resin having resistance to heat at 300° C. or more is used in a portion that comes into contact with a control fluid.

In accordance with the invention according to claim 6, the valve disk includes: the seal retention member including the cylindrical portion mating the cylindrical inner surface with the inner peripheral surface of the annular accommodation portion, and retaining the annular seal member at the position concentric with the retention portion; and the annular cushion member that is sandwiched between the surface, facing the bottom surface of the annular accommodation portion, of the seal retention member and the annular seal member, and the bottom surface, includes the inner peripheral surface mated with the inner peripheral surface of the annular accommodation portion, and is retained in the annular accommodation portion at the position concentric with the retention portion, and the annular seal member is retained in the annular accommodation portion in a state in which the annular seal member extends more radially outwardly than the annular cushion member, and the gap is formed between the surface of the annular seal member, facing the bottom surface of the annular accommodation portion, and the bottom surface.

As a result, due to a simple configuration in which the annular cushion member mated with the cylindrical portion of the seal retention member, and retained at the position concentric with the retention portion on the bottom surface side of the annular accommodation portion, and the gap between the annular seal member in the outer-diameter region of the annular cushion member and the bottom surface of the annular accommodation portion are disposed, in the case of compressing the annular cushion member toward the bottom surface of the annular accommodation portion, the annular seal member abutting on the valve seat is compressed together with the annular cushion member toward the bottom surface while effectively exhibiting the cushioning property of the annular cushion member with the use of the gap between the annular seal member and the annular accommodation portion, and is deformed for alignment with the use of the gap.

The annular cushion member is positioned on the bottom surface side of the annular accommodation portion, and is prevented from coming into contact with a control fluid by the seal retention member and the annular seal member. Therefore, the deterioration of the cushioning property due to the influence of temperature can be prevented, and a material with a high cushioning property can be used in the annular cushion member even if the heat resistance of the material is lower than that of the annular seal member.

Therefore, in accordance with the invention according to claim 6, performance for alignment can be improved while keeping airtightness in a simple configuration even under an environment at wide temperatures.

### BRIEF DESCRIPTION OF THE DRAWINGS

FIG. 1 is a cross-sectional view illustrating the schematic configuration of a diaphragm valve according to an embodiment in a valve opening state;

FIG. 2 is a cross-sectional view illustrating the schematic configuration of the diaphragm valve according to the embodiment in a valve closing state;

FIG. 3A is an enlarged view of the valve disk of the diaphragm valve illustrated in FIG. 1;

FIG. 3B is an enlarged view of a further enlarged portion in the vicinity of the annular accommodation portion of a retention portion illustrated in FIG. 3A;

FIG. 4 is an exploded perspective view of the valve disk;

FIG. 5 is a perspective view of an annular seal member viewed from a surface facing the bottom surface of the annular accommodation portion;

FIG. 6 is a perspective view of a seal retention member viewed from a surface facing the bottom surface of the annular accommodation portion;

FIG. 7 is a view for explaining the operation of each member disposed in the retention portion of the valve disk in the valve closing operation of the diaphragm valve; and

FIG. 8 is a cross-sectional view of the valve disk of a diaphragm valve of which the configuration is different from that of the diaphragm valve according to the embodiment.

### DETAILED DESCRIPTION OF THE INVENTION

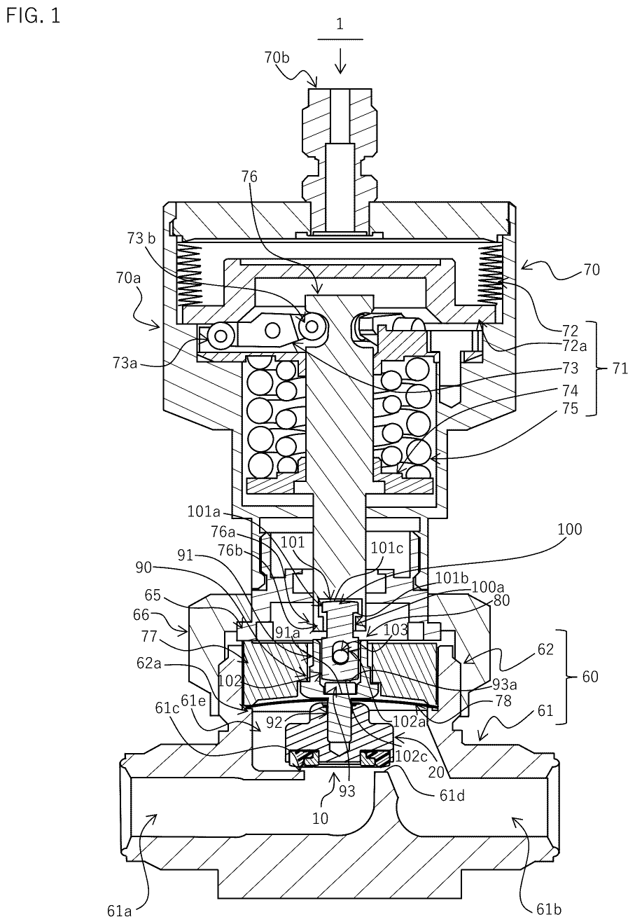

An embodiment of a diaphragm valve 1 according to the present invention is described in detail below with reference to FIGS. 1 to 7.

The present disclosure is not limited by the embodiment described below. It is necessary to note that the drawings are schematic, and the relationship of the dimension of each element, the proportion of each element, and the like may be different from reality. In the interrelationship among the drawings, the drawings may include portions of which the relationships of the dimensions, and the proportions are different from each other.

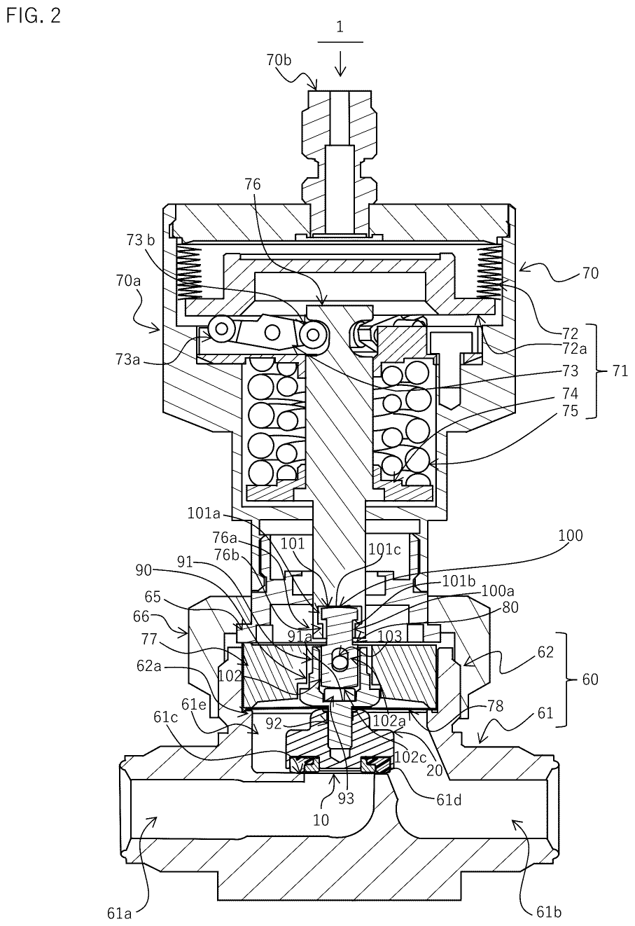

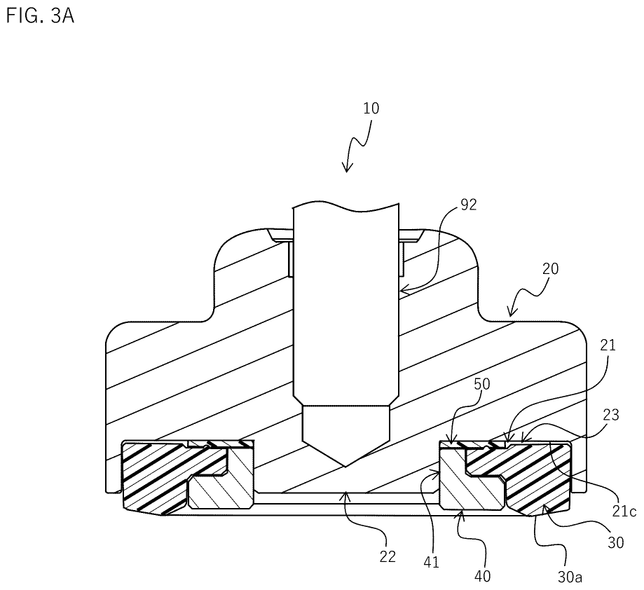

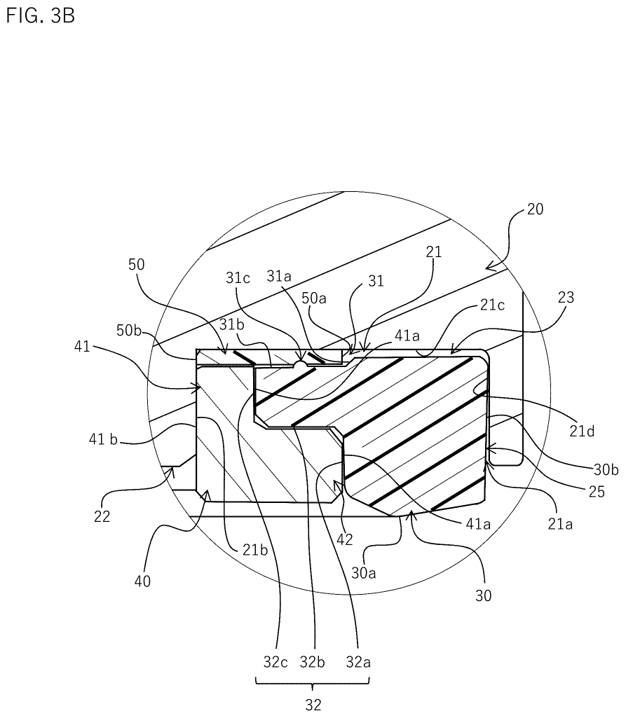

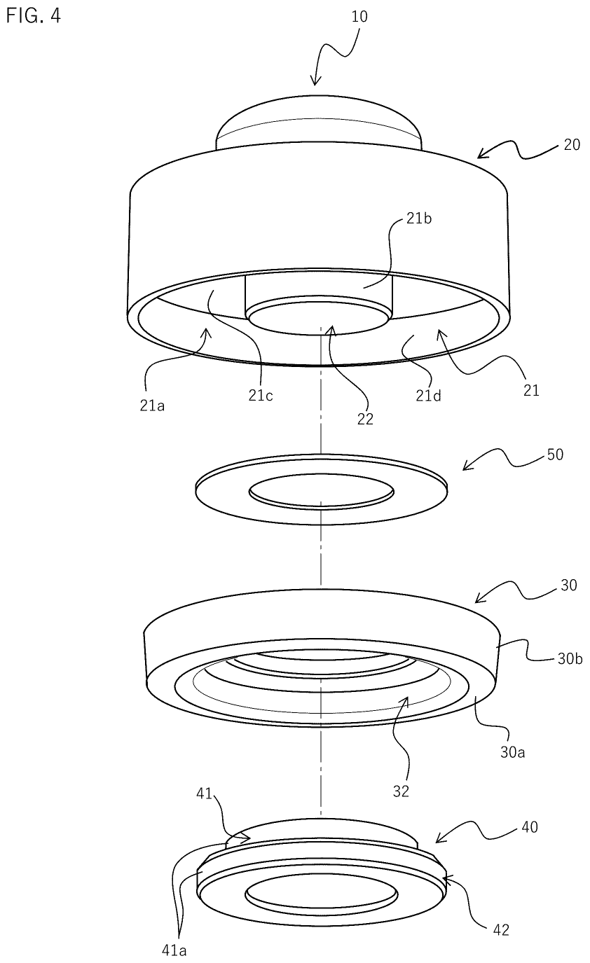

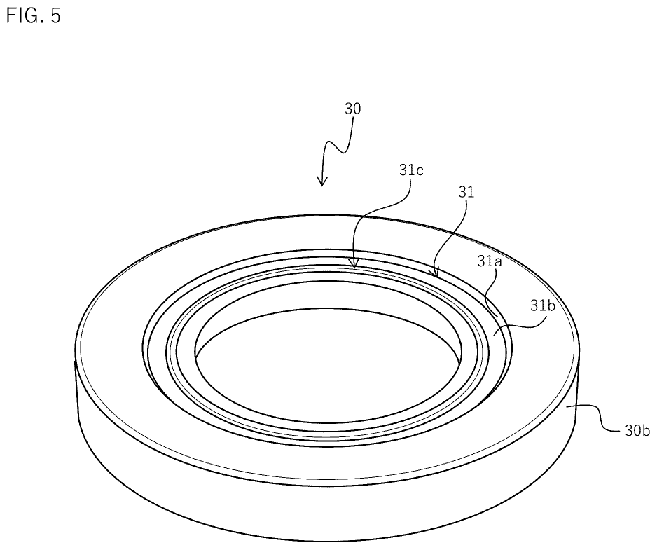

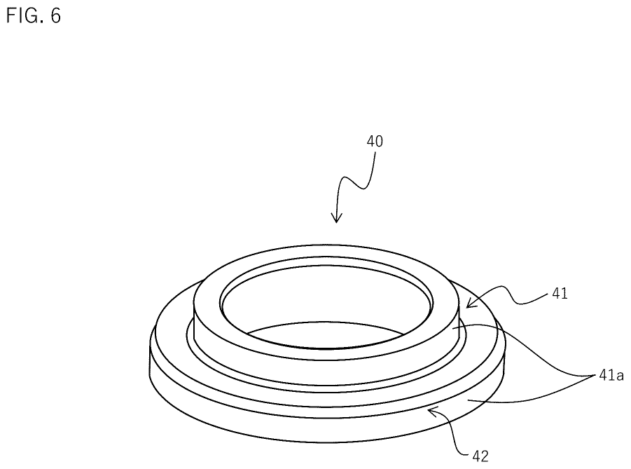

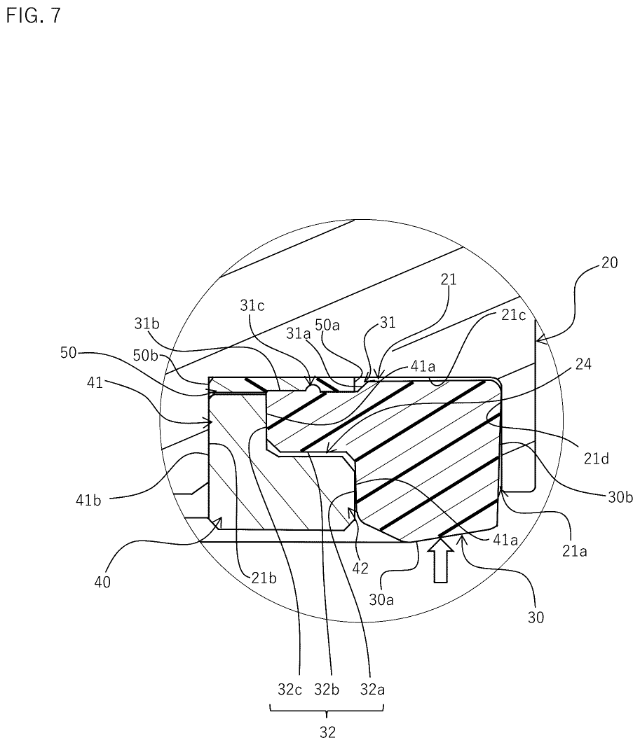

FIG. 1 is a cross-sectional view illustrating the schematic configuration of the diaphragm valve 1 according to the embodiment in a valve opening state. FIG. 2 is a cross-sectional view illustrating the schematic configuration of the diaphragm valve 1 according to the embodiment in a valve closing state. FIG. 3A is an enlarged view of the valve disk 10 of the diaphragm valve 1 illustrated in FIG. 1. FIG. 3B is an enlarged view of a further enlarged portion in the vicinity of the annular accommodation portion 21 of a retention portion 20 illustrated in FIG. 3A. FIG. 4 is an exploded perspective view of the valve disk 10. FIG. 5 is a perspective view of an annular seal member 30 viewed from a surface facing the bottom surface 21c of the annular accommodation portion 21. FIG. 6 is a perspective view of a seal retention member 40 viewed from a surface facing the bottom surface 21c of the annular accommodation portion 21. FIG. 7 is a view for explaining the operation of each member disposed in the retention portion 20 of the valve disk in the valve closing operation of the diaphragm valve 1.

The diaphragm valve 1 according to the embodiment of the present invention is used, for example, under an environment at 300° C. or more. The diaphragm valve 1 can also be used in any place other than high-temperature environments. For example, the diaphragm valve 1 can be used not only under a normal-temperature environment but also under a low-temperature environment.

The diaphragm valve 1 includes the valve disk 10, a body 60, and an actuator 70 that is assembled above the body 60.

### Valve Disk 10

The valve disk 10 is suspended by a diaphragm 78 airtightly sealing a valve chamber 61e, includes the retention portion 20 retaining the annular seal member 30, and is moved in conjunction with a stem 76 so that the annular seal member 30 is at a valve closing position at which the annular seal member 30 abuts on a valve seat surface 61d or at a valve opening position at which the annular seal member 30 is apart from the valve seat surface 61d.

The valve disk 10 includes the retention portion 20, the annular seal member 30, the seal retention member 40, and an annular cushion member 50, as illustrated in FIGS. 3 and 4.

### Retention Portion 20 of Valve Disk 10

The retention portion 20 includes a metallic material such as, for example, a stainless steel material, and includes the annular accommodation portion 21 that retains the annular seal member 30 and is annular.

In the annular accommodation portion 21, an opening 21a is formed in a side facing the valve seat surface 61d, and a cylindrical portion 22 that forms the inner peripheral surface 21b of the annular accommodation portion 21 is disposed in the center.

An outer peripheral surface which is the inner peripheral surface 21b of the annular accommodation portion 21 is mated with the cylindrical inner surface 41b of the seal retention member 40 and the inner peripheral surface 50b of the annular cushion member 50, whereby the cylindrical portion 22 functions as a portion that retains the seal retention member 40 and the annular cushion member 50 in the annular accommodation portion 21 in a state in which the seal retention member 40 and the annular cushion member 50 are located at positions concentric with the retention portion 20.

### Annular Seal Member 30 of Valve Disk 10

In this embodiment, the annular seal member 30 includes a polyimide resin with high heat resistance, and is retained in the annular accommodation portion 21 in a state in which the annular seal member 30 extends more radially outwardly than the annular cushion member 50, and a gap 23 is formed between the surface of the annular seal member 30, facing the bottom surface 21c of the annular accommodation portion 21, and the bottom surface 21c.

The annular seal member 30 is retained in the annular accommodation portion 21 by the seal retention member 40 in a state in which the annular seal member 30 is located at a position concentric with the retention portion 20, as described above.

A recess 31 in which the annular cushion member 50 is placed is formed on the annular seal member 30 so that the surface, facing the bottom surface 21c of the annular accommodation portion 21, of the annular seal member 30, is provided with a peripheral side 31a slightly separated from the outer peripheral surface 50a of the annular cushion member 50, as illustrated in FIGS. 3B and 5.

The gap 23 is formed between the bottom surface 21c of the annular accommodation portion 21 and a surface of the annular seal member 30 that is more radially outwardly than the recess 31 of the annular seal member 30.

The width of the gap 23 is adjusted so that the cushioning property of the annular cushion member 50 is effectively exhibited, and the annular seal member 30 can be deformed for alignment, when the annular seal member 30 abuts on the valve seat surface 61d and is compressed because the valve disk 10 is moved to the valve closing position.

The bottom surface 31b of the recess 31 is provided with an annular projection 31c that is brought into press contact with the surface of the annular cushion member 50.

The annular projection 31c is a portion that increases the degree of adhesion between the annular seal member 30 and the annular cushion member 50 in a region that is more radially inwardly located than a region in which the gap 23 is formed, so that the route of the entry of a control fluid into the gap 23 described above is interrupted.

A stage-shaped abutment surface 32 abutting in a stage shape on the outer peripheral surface 41a of a cylindrical portion 41 including the collar portion 42, described later, of the seal retention member 40 is formed on the annular seal member 30, as illustrated in FIG. 3B.

The stage-shaped abutment surface 32 includes: a first abutment surface 32a that abuts on the outer peripheral surface 41a of the collar portion 42; a second abutment surface 32b that abuts on a surface of the collar portion 42, facing the bottom surface 21c of the annular accommodation portion 21; and a third abutment surface 32c that abuts on an outer peripheral surface of an end, facing the bottom surface 21c of the annular accommodation portion 21 of the seal retention member 40.

The first abutment surface 32a and the third abutment surface 32c are the inner peripheral surfaces of the annular seal member 30, described as surfaces that abut on the outer peripheral surface 41a of the seal retention member 40 when the annular seal member 30 is placed at a position concentric with the retention portion 20 by the seal retention member 40.

When the valve disk 10 is at the valve opening position, that is, when the annular seal member 30 is in an elastically neutral state in which the annular seal member 30 is not compressed, the annular seal member 30 is in a state in which the three first to third abutment surfaces 32a, 32b, and 32c abut on the corresponding surfaces of the seal retention member 40, respectively.

The outer peripheral surface 30b of the annular seal member 30 is disposed at a slant so that the outer diameter of the annular seal member 30 is enlarged from the vicinity of the valve seat surface 61d toward the bottom surface 21c of the annular accommodation portion 21.

As a result, the outer peripheral surface 30b of the annular seal member 30 is brought into intimate contact with the outer peripheral surface 21d of the annular accommodation portion 21 in the vicinity of the bottom surface 21c of the annular accommodation portion 21 while reducing the area of the annular seal member 30, coming into contact with the annular accommodation portion 21, to a small area.

Therefore, a control fluid is reliably prevented from entering the gap 23 through between the outer peripheral surface 30b of the annular seal member 30 and the outer peripheral surface 21d of the annular accommodation portion 21.

### Seal Retention Member 40 of Valve Disk 10

The seal retention member 40 includes a metal material such as, for example, a stainless steel material, includes the cylindrical portion 41 mating the cylindrical inner surface 41b with the inner peripheral surface 21b of the annular accommodation portion 21, and retains the annular seal member 30 at the position concentric with the retention portion 20.

The seal retention member 40 includes the collar portion 42 radially outwardly protruded in a collar shape on the end of the cylindrical portion 41, and abuts on the stage-shaped abutment surface 32 of the annular seal member 30.

The inner peripheral surfaces 32a and 32c are mated with the outer peripheral surface 41a of the cylindrical portion 41, whereby the annular seal member 30 is retained at a position concentric with the retention portion 20 in the annular accommodation portion 21.

The seal retention member 40 is prevented from abutting on the valve seat surface 61d by adjusting the seal retention member 40 so that the surface facing the valve seat surface 61d is at a position that is lower than the position of the valve seat abutment surface 30a of the annular seal member 30, facing the valve seat surface 61d.

### Annular Cushion Member 50 of Valve Disk 10

The annular cushion member 50 is an annular sheet member having a cushioning property. In this embodiment, the annular cushion member 50 includes a perfluoroalkoxy alkane resin. In other words, in this embodiment, a material of which the cushioning property is higher than that of the annular seal member 30 is used as the annular cushion member 50.

In the present embodiment, the cushioning property is a property having followability allowing an object to flexibly follow the shape of another object with which the object comes into contact, and to be deformed, and elasticity allowing the object to be restored from a state in which the object is compressed and deformed.

The high cushioning property refers to a property having high followability while having elasticity allowing an object to be restored from a state in which the object is compressed and deformed.

The annular cushion member 50 is sandwiched between the surface, facing the bottom surface 21c of the annular accommodation portion 21, of the seal retention member 40 and the annular seal member 30, and the bottom surface 21c of the annular accommodation portion 21, includes the inner peripheral surface 50b mated with the inner peripheral surface 21b of the annular accommodation portion 21, and is retained in the annular accommodation portion 21 at the position concentric with the retention portion 20.

A material of which the cushioning property is equivalent to that of the annular seal member 30 may be used as the annular cushion member 50 as long as the material has the cushioning property. The reason thereof is because the annular cushion member 50 is placed at a position at which the annular cushion member 50 does not come into direct contact with a control fluid having a high temperature, and therefore, the deterioration of the cushioning property can be prevented even under environments at wide temperatures, including a high-temperature environment.

### Body 60

The body 60 includes a metallic material, and is provided integrally with: a main body 61 in which a flow path for a gas as a control fluid is formed; and a linkage portion 62 that is linked to the actuator 70.

The main body 61 is provided with a primary side flow path 61a as a gas inflow side and a secondary side flow path 61b as a gas outflow side so that a valve seat 61c including the flat valve seat surface 61d with and from which the annular seal member 30 of the valve disk 10 is contacted and separated is between the primary side flow path 61a and the secondary side flow path 61b.

The linkage portion 62 is cylindrically protruded from the main body 61 and disposed at a position above the valve seat 61c assembled with the actuator 70. An annular stage 62a seated in a state in which a bonnet 77 sandwiches the outer peripheral edge of the diaphragm 78 is formed on the inner peripheral surface of the linkage portion 62.

Linkage members 65 and 66 are allowed to exist between the linkage portion 62 and the actuator 70, whereby the linkage portion 62 links the main body 61 and the actuator 70 to each other.

### Actuator 70

The actuator 70 moves the stem 76 to a valve opening and closing position in an up-and-down manner. In the actuator 70, an elevator mechanism 71 that moves the stem 76 in an up-and-down manner, and a mechanism 80 for pulling-up and alignment, having a function of pulling up the valve disk 10 in conjunction with the operation of the rising of the stem 76 at the time of opening the valve and a function of aligning the valve disk 10 at the time of closing the valve are disposed in a case 70a.

### Elevator Mechanism 71 of Actuator 70

The elevator mechanism 71 includes: a bellows 72 that is provided with a bellows flange 72a in an lower end, internally receives air introduced from an air introduction coupling 70b, and includes a metallic material; a plurality of cams 73 that are provided with rollers 73a and 73b in both ends and are pivoted on the inner wall of the case 70a; and a spring 75 that applies a force for moving the stem 76 to the valve closing position in a lower area through a retainer 74.

In each cam 73, the roller 73a in one end is placed abuttably on the outer peripheral edge of the bellows flange 72a, and the roller 73b in the other end is placed in a groove formed in an annular shape on the upper outer peripheral surface of the stem 76. The plurality of such cams 73 are dispersedly placed around the outer periphery of the stem 76.

### Mechanism 80 for Pulling-Up and Alignment, of Actuator 70

The mechanism 80 for pulling-up and alignment includes a diaphragm piece 90 and a linkage member 100.

The configuration of the mechanism 80 for pulling-up and alignment includes a lower end recess 76a disposed in the lower end of the stem 76.

### Diaphragm Piece 90 of Mechanism 80 for Pulling-Up and Alignment

The diaphragm piece 90 is linked to the valve disk 10, and is ascendably and descendably retained by the bonnet 77. The outer peripheral edge of the diaphragm 78 is sandwiched between the bonnet 77 and the body 60. The inner circumferential edge of the diaphragm 78 is sandwiched between the diaphragm piece 90 and the retention portion 20 of the valve disk 10.

The diaphragm piece 90 is provided with an upper end recess 91 which has a cylindrical, bottomed shape, in which the lower end of the linkage member 100 is placed in a loose-fit state, and of which the upper end is opened.

The shape of the diaphragm may be, for example, a wave shape or a dome shape.

In the present embodiment, a spacer 93 is placed on the bottom surface 91a of the upper end recess 91 of the diaphragm piece 90, and the upper surface 93a of this spacer 93 forms the bottom surface 91a of the upper end recess 91.

Therefore, the state of the bottom surface of the upper end recess 91 abutting on the linkage member 100 can be adjusted as appropriate, for example, by adjusting the shape, material, hardness, surface state, thickness, and number of such spacers 93.

The planar state of the bottom surface of the upper end recess 91 can be adjusted to a state suitable for alignment, for example, by allowing the upper surface 93a of the spacer 93 to be a flat surface, or adjusting surface roughness.

The material of the spacer 93 can be adjusted to a state suitable for alignment by allowing the material of the spacer 93 to be different from that of the linkage member 100 to preclude the galling of the linkage member 100.

A state in which the linkage member 100 and the bottom surface 91a of the upper end recess 91 abut on each other across the spacer 93 can be adjusted to a state suitable for alignment by adjusting the thickness or number of such spacers 93.

A male screw portion 92 that is engaged threadedly to the retention portion 20 of the valve disk 10 through a through-hole formed in the center of the diaphragm 78 is disposed in the lower end of the diaphragm piece 90, and the inner circumferential edge of the diaphragm 78 is sandwiched between the bottom surface of the diaphragm piece 90 around the base end of the male screw portion 92 and the upper end surface of the retention portion 20.

### Linkage Member 100 of Mechanism 80 for Pulling-Up and Alignment

The outer shell of the linkage member 100 has a generally columnar shape. In the linkage member 100, a linkage through-hole 102a is formed in a direction generally perpendicular to an axis direction. The linkage member 100 is linked to the diaphragm piece 90 via a linkage pin 103 inserted through the linkage through-hole 102a, and is linked to the stem 76 via a stage to be locked 101a, which is locked at a locking stage 76b disposed on the lower end recess 76a of the stem 76.

In the linkage member 100, an annular recess 100a is formed on the outer peripheral surface of the linkage member 100, whereby a head 101 is formed in the upper portion of the linkage member 100, and a trunk 102 having a columnar shape is formed in the lower portion of the linkage member 100, below the annular recess 100a.

The head 101 is placed in a loose-fit state in the lower end recess 76a of the stem 76 so that the lower surface of the head 101 is the surface to be locked 101b of the stage to be locked 101a, which is locked at the locking stage 76b disposed on the lower end recess 76a of the stem 76.

The linkage through-hole 102a described above is formed in the trunk 102. The trunk 102 is placed in a loose-fit state in the upper end recess 91 of the diaphragm piece 90 by the linkage pin 103 inserted into the linkage through-hole 102a through an unillustrated through-hole formed in the upper end recess 91 of the diaphragm piece 90.

The linkage through-hole 102a has a long-hole shape in which the direction of elevating the stem 76 is a longitudinal direction. More specifically, a backlash in which the linkage member 100 can be moved downward so that the lower end surface of the linkage member 100 abuts on the bottom surface of the upper end recess 91 of the diaphragm piece 90, that is, the upper surface of the spacer 93 when the stem 76 is moved down for closing the valve is disposed by setting the dimension of the linkage through-hole 102a in the longitudinal direction at a larger dimension than the diameter of the linkage pin 103.

### Valve Opening and Closing Operation of Diaphragm Valve 1

The valve opening and closing operation of the diaphragm valve 1 is described below with reference to FIGS. 1, 2, and 7.

First, the valve opening operation of the diaphragm valve 1 is described. The bellows 72 expands to bring the lower surface of the bellows flange 72a disposed in the lower portion of the bellows 72 and the roller 73a in one end of each cam 73 to come into contact with each other when air is supplied into the bellows 72 through the air introduction coupling 70b in the case of changing the diaphragm valve 1 from a valve closing state (see FIG. 2) to a valve opening state (see FIG. 1).

Then, the cam 73 rotates so that the other end is inclined upward. The roller 73b in the other end lifts stem 76, whereby the stem 76 is moved upward.

When the stem 76 is moved upward, the locking stage 76b of the lower end recess 76a of the stem 76 abuts on the surface to be locked 101b of the linkage member 100 to pull up the linkage member 100, and the lower hole inner edge surface of the linkage through-hole 102a of the linkage member 100 abuts on the linkage pin 103 to lift the diaphragm piece 90, whereby the diaphragm piece 90 is moved upward.

When the diaphragm piece 90 is moved upward, the valve disk 10 linked to the diaphragm piece 90 is moved upward to achieve the valve opening state in which the annular seal member 30 is apart from the valve seat surface 61d.

In such a case, the diaphragm 78 is elastically restored in a state in which the periphery of the inner circumferential edge sandwiched between the diaphragm piece 90 and the retention portion 20 of the valve disk 10 is pulled upward and swells.

Moreover, the annular seal member 30 that abuts on the valve seat surface 61d and is compressed and the annular cushion member 50 that is compressed through the annular seal member 30 are elastically restored.

Next, the valve closing operation of the diaphragm valve 1 is described.

When the diaphragm valve 1 is changed from the above-described valve opening state to the valve closing state, supply of air into the bellows 72 through the air introduction coupling 70b is stopped, the retainer 74 is pushed down by the elastic force of the spring 75, and the stem 76 locked at the retainer 74 is moved down.

When the stem 76 is moved down, the bottom surface of the lower end recess 76a of the stem 76 abuts on the arc-shaped curved surface 102c of the upper end surface of the linkage member 100 to push down the linkage member 100. Thus, the arc-shaped curved surface 102c of the lower end surface of the linkage member 100 abuts on the upper surface of the spacer 93 to push down the diaphragm piece 90.

The diaphragm piece 90 is pushed down in such a manner, whereby the valve disk 10 linked to the diaphragm piece 90 is moved down to achieve the valve closing state in which the annular seal member 30 abuts on the valve seat surface 61d.

When the annular seal member 30 is moved down in such a manner, the downward movement of the stem 76 allows the linkage member 100 to abut on both the bottom surfaces of the lower end recess 76a of the stem and the upper end recess 91 of the diaphragm piece 90 to transfer the force of the stem 76 in the axis direction to the diaphragm piece 90.

This is because the linkage member 100 is placed in a loose-fit state on each of the lower end recess 76a of the stem 76 and the upper end recess 91 of the diaphragm piece 90, the bottom surface of the lower end recess 76a of the stem 76 abuts on an upper end surface 101c forming the arc-shaped curved surface of the linkage member 100, and the bottom surface of the upper end recess 91 of the diaphragm piece 90, more specifically, the upper surface of the spacer 93 abuts on the lower end surface 102c forming the arc-shaped curved surface of the linkage member 100, regardless of the posture of the diaphragm piece 90.

Therefore, the diaphragm piece 90 is aligned, and the annular seal member 30 abuts on the valve seat surface 61d in a state in which the valve disk 10 is aligned, even in a case in which the diaphragm piece 90 wobbles toward the bonnet 77, whereby the diaphragm piece 90 inclines with respect to the axis of the stem 76, whereby the valve disk 10 linked to the diaphragm piece 90 inclines.

When the annular seal member 30 abuts on the valve seat surface 61d in such a manner, and then, the valve disk 10 is further moved down in conjunction with the stem 76, the annular seal member 30 is compressed by a reaction force received from the valve seat surface 61d, and the annular cushion member 50 overlapping with the annular seal member 30 on the bottom surface side of the annular accommodation portion 21 is compressed, as illustrated in FIG. 7.

The annular cushion member 50 is elastically compressed and deformed while flexibly following the annular seal member 30 when the annular cushion member 50 is pressed by the annular seal member 30. In other words, the annular cushion member 50 is compressed and deformed in a state in which the annular cushion member 50 comes into intimate contact with the annular seal member 30, and in a state in which the annular cushion member 50 is pressed by the bottom surface 21c of the annular accommodation portion 21, without generation of a gap between the annular cushion member 50 and the annular seal member 30.

Therefore, the annular seal member 30 coming into contact with the valve seat surface 61d further adds the cushioning property of the annular cushion member 50 to the cushioning property of the annular seal member 30 in itself to enhance cushion performance, and is deformed to follow the valve seat surface 61d.

The disposition of the above-described gap 23 enables the cushioning property of the annular cushion member 50 to be effectively utilized in a period from the abutment of the annular seal member 30 on the valve seat surface 61d to the abutment of the annular seal member 30 on the bottom surface 21c of the annular accommodation portion 21 while compressing the annular seal member 30.

Moreover, the annular seal member 30 is deformed to align the valve disk 10 with the use of the gap 23.

In other words, in this embodiment, performance for alignment is further enhanced in the valve disk 10 together with the mechanism 80 for pulling-up and alignment that is disposed independently of the valve disk 10.

A gap 24 is generated between the annular seal member 30 and the seal retention member 40, as illustrated in FIG. 7, when the annular seal member 30 and the annular cushion member 50 are compressed by a reaction force received by the annular seal member 30 from the valve seat surface 61d. However, except that the gap 24 is formed, the stage-shaped abutment surface 32 of the annular seal member 30 swells toward the corresponding surface of the seal retention member 40, whereby the stage-shaped abutment surface 32 further comes into intimate contact with the corresponding surface of the seal retention member 40. Therefore, a control fluid can be prevented from entering the gap.

### Effects of Embodiment

As described above, in accordance with the diaphragm valve 1 according to the embodiment, the valve disk 10 includes: the seal retention member 40 including the cylindrical portion 41 mating the cylindrical inner surface 41b with the inner peripheral surface 21b of the annular accommodation portion 21, and retaining the annular seal member 30 at the position concentric with the retention portion 20; and the annular cushion member 50 that is sandwiched between the surface, facing the bottom surface 21c of the annular accommodation portion 21, of the seal retention member 40 and the annular seal member 30, and the bottom surface 21c of the annular accommodation portion 21, includes the inner peripheral surface 50b mated with the inner peripheral surface 21b of the annular accommodation portion 21, and is retained in the annular accommodation portion 21 at the position concentric with the retention portion 20, and the annular seal member 30 is retained in the annular accommodation portion 21 in a state in which the annular seal member 30 extends more radially outwardly than the annular cushion member 50, and the gap 23 is formed between the surface of the annular seal member 30, facing the bottom surface 21c of the annular accommodation portion 21, and the bottom surface 21c of the annular accommodation portion 21.

As a result, due to a simple configuration in which the annular cushion member 50 mated with the inner peripheral surface 21b of the annular accommodation portion 21, and retained at the position concentric with the retention portion 20 in the vicinity of the bottom surface 21c of the annular accommodation portion 21, and the gap 23 between the annular seal member 30 in the outer-diameter region of the annular cushion member 50 and the bottom surface 21c of the annular accommodation portion 21 are disposed, in the case of compressing the annular cushion member 50 toward the bottom surface 21c of the annular accommodation portion 21, the annular seal member 30 abutting on the valve seat surface 61d is compressed together with the annular cushion member 50 toward the bottom surface 21c while effectively exhibiting the cushioning property of the annular cushion member 50 with the use of the gap 23 between the annular seal member 30 and the annular accommodation portion 21, and is deformed for alignment with the use of the gap 23.

The annular cushion member 50 is positioned in the vicinity of the bottom surface 21c of the annular accommodation portion 21, and is prevented from coming into contact with a control fluid by the seal retention member 40 and the annular seal member 30. Therefore, the deterioration of the cushioning property due to the influence of temperature can be prevented, and a material with a high cushioning property can be used in the annular cushion member 50 even if the heat resistance of the material is lower than that of the annular seal member 30.

Therefore, in accordance with the diaphragm valve 1 according to the embodiment, performance for alignment can be improved while keeping airtightness in a simple configuration even under environments at wide temperatures, including a high-temperature environment.

In accordance with the diaphragm valve 1 according to the embodiment, the valve disk 10 is aligned with the further use of the function of alignment of the valve disk 10 in itself, while aligning the valve disk 10 by the mechanism 80 for pulling-up and alignment that is disposed independently of the valve disk 10. Therefore, performance for alignment can be improved, and, in particular, performance for alignment for a large-sized valve difficult to align can also be improved.

In accordance with the diaphragm valve 1 according to the embodiment, the annular cushion member 50 includes the material of which the cushioning property is higher than that of the annular seal member 30. Therefore, the followability of the annular seal member 30 to the valve seat surface 61d is enhanced with the use of the cushioning property of the annular cushion member 50, and, as a result, airtightness can be enhanced.

In accordance with the diaphragm valve 1 according to the embodiment, the seal retention member 40 includes the collar portion 42 radially outwardly protruded in the collar shape on the end of the cylindrical portion 41, and the stage-shaped abutment surface 32 abutting in the stage shape on the outer peripheral surface 41a of the cylindrical portion 41 including the collar portion 42 is formed on the annular seal member 30. Therefore, in a case in which the annular seal member 30 abuts on the valve seat 61c and is compressed, the entry of a control fluid through the stage-shaped abutment portion between the seal retention member 40 and the annular seal member 30 is prevented even if the annular seal member 30 is relatively moved in the axis direction with respect to the seal retention member 40, and therefore, the control fluid can be prevented from entering the gap 23 between the annular seal member 30 and the bottom surface 21c of the annular accommodation portion 21.

In accordance with the diaphragm valve 1 according to the embodiment, the recess 31 in which the annular cushion member 50 is placed is formed on the annular seal member 30 so that the surface, facing the bottom surface 21c of the annular accommodation portion 21, of the annular seal member 30, is provided with the peripheral side 31a slightly separated from the outer peripheral surface 50a of the annular cushion member 50, and the gap 23 is formed between the bottom surface 21c of the annular accommodation portion 21 and the surface of the annular seal member 30 that is more radially outwardly than the recess 31. Therefore, such a minimum gap 23 that the annular cushion member 50 can exert cushion performance can be disposed, and, as a result, the minimum gap 23 that enables airtightness to be enhanced can be disposed.

In accordance with the diaphragm valve 1 according to the embodiment, the annular seal member 30 includes polyimide, and the annular cushion member 50 includes a perfluoroalkoxy alkane resin. Therefore, performance for alignment can be improved while keeping airtightness in a simple configuration even in use under an environment at 300° C. or more because the annular cushion member 50 including a perfluoroalkoxy alkane resin of which the cushioning property is higher than that of the polyimide resin although the perfluoroalkoxy alkane resin has resistance to heat at less than 300° C. is used in a portion that does not come into contact with a control fluid while the annular seal member 30 including a polyimide resin having resistance to heat at 300° C. or more is used in a portion that comes into contact with a control fluid.

In accordance with the valve disk 10 according to the embodiment, the valve disk 10 includes: the seal retention member 40 including the cylindrical portion 41 mating the cylindrical inner surface 41b with the inner peripheral surface 21b of the annular accommodation portion 21, and retaining the annular seal member 30 at the position concentric with the retention portion 20; and the annular cushion member 50 that is sandwiched between the surface, facing the bottom surface of the annular accommodation portion 21, of the seal retention member 40 and the annular seal member 30, and the bottom surface 21c of the annular accommodation portion 21, includes the inner peripheral surface 50b mated with the inner peripheral surface 21b of the annular accommodation portion 21, and is retained in the annular accommodation portion 21 at the position concentric with the retention portion 20, and the annular seal member 30 is retained in the annular accommodation portion 21 in a state in which the annular seal member 30 extends more radially outwardly than the annular cushion member 50, and the gap 23 is formed between the surface of the annular seal member 30, facing the bottom surface 21c of the annular accommodation portion 21, and the bottom surface 21c of the annular accommodation portion 21.

As a result, due to a simple configuration in which the annular cushion member 50 mated with the cylindrical portion 41 of the seal retention member 40, and retained at the position concentric with the retention portion 20 in the vicinity of the bottom surface 21c of the annular accommodation portion 21, and the gap 23 between the annular seal member 30 in the outer-diameter region of the annular cushion member 50 and the bottom surface 21c of the annular accommodation portion 21 are disposed, in the case of compressing the annular cushion member 50 toward the bottom surface 21c of the annular accommodation portion 21, the annular seal member 30 abutting on the valve seat surface 61d is compressed together with the annular cushion member 50 toward the bottom surface 21c of the annular accommodation portion 21 while effectively exhibiting the cushioning property of the annular cushion member 50 with the use of the gap 23 between the annular seal member 30 and the annular accommodation portion 21, and is deformed for alignment with the use of the gap 23.

The annular cushion member 50 is positioned in the vicinity of the bottom surface 21c of the annular accommodation portion 21, and is prevented from coming into contact with a control fluid by the seal retention member 40 and the annular seal member 30. Therefore, the deterioration of the cushioning property due to the influence of temperature can be prevented, and a material with a high cushioning property can be used in the annular cushion member 50 even if the heat resistance of the material is lower than that of the annular seal member 30.

The embodiment of the present disclosure is described above. However, the present disclosure is not limited to the embodiment described above but can be subjected to various modifications without departing from the gist of the present disclosure.

For example, an example in which the annular seal member 30 includes a polyimide resin, and the annular cushion member 50 includes a perfluoroalkoxy alkane resin is described in the embodiment described above. However, materials included in the annular seal member 30 and the annular cushion member 50 are not limited to the resins. Other materials may be used in the annular seal member 30 and the annular cushion member 50 as long as the annular seal member 30 is a sealant, and the annular cushion member 50 is a member with a cushioning property.

In the embodiment described above, an example in which the mechanism 80 for pulling-up and alignment is disposed is described. However, it is also acceptable that the mechanism 80 for pulling-up and alignment is not disposed but alignment is performed only using the function of alignment of the valve disk 10. In other words, in the diaphragm valve 1, the valve disk 10 may be linked to the stem 76 without the intervention of the mechanism 80 for pulling-up and alignment.

The present inventors conducted a high-temperature endurance test on a diaphragm valve of which the configuration of the valve disk is different from the configuration of the valve disk of the diaphragm valve 1 of the embodiment described above.

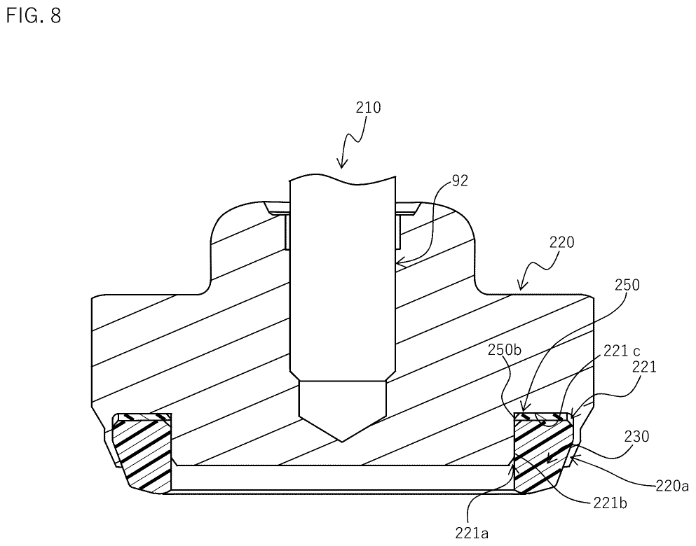

FIG. 8 is a cross-sectional view of a valve disk 210 used in a diaphragm valve of which the configuration is different from that of the diaphragm valve according to the embodiment.

In the diaphragm valve, the valve disk 210 includes an annular cushion member 250 that is sandwiched between a surface, facing the bottom surface 221c of an annular accommodation portion 221, of an annular seal member 230, and the bottom surface 221c of the annular accommodation portion 221, includes an inner peripheral surface 250b mated with the inner peripheral surface 221b of the annular accommodation portion 221, and is retained in the annular accommodation portion 221 at a position concentric with a retention portion 220.

In the diaphragm valve, the retention portion 220 includes a caulking portion 220a, and the annular seal member 230 is retained in the annular accommodation portion 221 by the caulking portion 220a.

The test conditions of the high-temperature endurance test are described below.
Test conditions:
Annular seal member: polyimide resin
Annular cushion member: perfluoroalkoxy alkane resin

The opening and closing operation of a valve is performed 200000 times under an environment at a temperature of 300° C.

As the results of the high-temperature endurance test, the diaphragm valve had no problem in a case in which the number of times of opening and closing was 100000, but contact between the annular seal member 230 and the caulking portion 220a caused particles to be generated in a case in which the number of times of opening and closing was 200000.

In contrast, in the diaphragm valve 1 of the present embodiment, the retention portion 20 is not provided with the caulking portion 220a, the annular seal member 30 is retained by the seal retention member 40 which is a member different from the retention portion 20, and therefore, the diaphragm valve 1 is also effective at preventing generation of particles.

Moreover, the outer peripheral surface 30b of the annular seal member 30 is disposed at a slant so that the outer diameter of the annular seal member 30 is enlarged from the vicinity of the valve seat surface 61d toward the bottom surface 21c of the annular accommodation portion 21, and the contact area between the annular seal member 30 and the annular accommodation portion 21 is reduced to a small area. Therefore, the annular seal member 30 can be effectively prevented from coming into contact with the annular accommodation portion 21 and resulting in generation of particles.

Moreover, a slight gap 25 (see FIG. 3B) is formed in the vicinity of the opening 21a of the annular accommodation portion 21 between the outer peripheral surface 30b and the outer peripheral surface 21d of the annular accommodation portion 21 by disposing the outer peripheral surface 30b of the annular seal member 30 at a slant. Therefore, deformation for alignment can be further facilitated with the use of the gap 25 when the annular seal member 30 is aligned with the use of the gap 23.

Each embodiment disclosed herein should be considered to be exemplary in every respect, and not to be limiting. The embodiments described above may be omitted, substituted, or modified in various forms without departing from the appended claims and the gist of the claims.

What is claimed is:

1. A diaphragm valve comprising a valve disk that is suspended by a diaphragm airtightly sealing a valve chamber, comprises a retention portion retaining an annular seal member in an annular accommodation portion, and is moved in conjunction with a stem so that the annular seal member is at a valve closing position at which the annular seal member abuts on a valve seat surface or at a valve opening position at which the annular seal member is apart from the valve seat surface, wherein
the valve disk comprises: a seal retention member comprising a cylindrical portion mating a cylindrical inner surface with an inner peripheral surface of the annular accommodation portion, and retaining the annular seal member at a position concentric with the retention portion; and an annular cushion member that is sandwiched between a surface, facing a bottom surface of the annular accommodation portion, of the seal retention member and the annular seal member, and the bottom surface, comprises an inner peripheral surface mated with an inner peripheral surface of the annular accommodation portion, and is retained in the annular accommodation portion at a position concentric with the retention portion, and
the annular seal member is retained in the annular accommodation portion in a state in which the annular seal member extends more radially outwardly than the annular cushion member, and a gap is formed between a surface of the annular seal member, facing the bottom surface of the annular accommodation portion, and the bottom surface.

2. The diaphragm valve according to claim 1, wherein the annular cushion member comprises a material of which a cushioning property is higher than that of the annular seal member.

3. The diaphragm valve according to claim 1, wherein
the seal retention member comprises a collar portion radially outwardly protruded in a collar shape on an end of the cylindrical portion, and
a stage-shaped abutment surface abutting in a stage shape on an outer peripheral surface of the cylindrical portion comprising the collar portion is formed on the annular seal member.

4. The diaphragm valve according to claim 1, wherein
a recess in which the annular cushion member is placed is formed on the annular seal member so that the surface, facing the bottom surface of the annular accommodation portion, of the annular seal member, is provided with a peripheral side slightly separated from an outer peripheral surface of the annular cushion member, and
the gap is formed between the bottom surface of the annular accommodation portion and a surface of the annular seal member that is more radially outwardly than the recess.

5. The diaphragm valve according to according to claim 1, wherein
the annular seal member comprises a polyimide resin, and
the annular cushion member comprises a perfluoroalkoxy alkane resin.

6. A valve disk that is suspended by a diaphragm airtightly sealing a valve chamber, comprises a retention portion retaining an annular seal member in an annular accommodation portion, and is moved in conjunction with a stem so that the annular seal member is at a valve closing position at which the annular seal member abuts on a valve seat surface or at a valve opening position at which the annular seal member is apart from the valve seat surface, wherein
the valve disk comprises: a seal retention member comprising a cylindrical portion mating a cylindrical inner surface with an inner peripheral surface of the annular accommodation portion, and retaining the annular seal member at a position concentric with the retention portion; and an annular cushion member that is sandwiched between a surface, facing a bottom surface of the annular accommodation portion, of the seal retention member and the annular seal member, and the bottom surface, comprises an inner peripheral surface mated with an inner peripheral surface of the annular accommodation portion, and is retained in the annular accommodation portion at a position concentric with the retention portion.
